(19) United States
(12) Patent Application Publication
(10) Pub. No.: US 2022/0167237 A1
(43) Pub. Date: May 26, 2022

(54) COMMUNICATION DEVICE AND COMMUNICATION METHOD

(71) Applicant: SONY GROUP CORPORATION, TOKYO (JP)

(72) Inventor: TAKESHI ITAGAKI, TOKYO (JP)

(21) Appl. No.: 17/437,660

(22) PCT Filed: Feb. 10, 2020
(86) PCT No.: PCT/JP2020/005047

§ 371 Date: Sep. 9, 2021

(30) Foreign Application Priority Data
Mar. 26, 2019 (JP) 2019-058905

(51) Int. Cl. H04W 36/14; H04L 67/02; H04W 12/06

(52) U.S. Cl. CPC H04W 36/14; H04W 12/06; H04L 67/02

(57) ABSTRACT

Provided is a communication device that resolves a Captive Portal state. A communication device includes: a first communication unit connected to a first network; a second communication unit connected to a second network;

and a control unit that controls a network operation in each of the first and second communication units, in which the control unit determines whether or not the second network is in a redirection state, and performs control to transmit information regarding redirection to the first network. Further, the control unit resolves the redirection of the second network on the basis of information received via the first network.

### TECHNICAL FIELD

A technology disclosed herein relates to a communication device that operates in a Captive Portal environment and a communication method.

### BACKGROUND ART

In some cases, a public wireless local area network (LAN) adopts a mechanism that requests web authentication when connecting to the Internet. Specifically, the mechanism is such that an access point of a wireless LAN performs redirection to a web portal (referred to as “Captive Portal” herein) that prevents access to the Internet until authentication is performed by inputting payment information, logging in, a password certificate, or agreeing to a provider service article.

Meanwhile, in a case where a device (such as a smartphone) including a plurality of network interfaces such as cellular communication and a wireless LAN switches connection to be used from the cellular communication to the wireless LAN, the device desirably confirms connection to the Internet via the wireless LAN and switches the connection after the confirmation succeeds. However, in a case where an access point to which the wireless LAN is connected requests web authentication, the device cannot be connected to the

Internet until authentication information is input and the authentication succeeds because the device is redirected to the Captive Portal by the access point. Such a state in which the device cannot be connected to the Internet because of the redirection is also referred to as “Captive Portal state” herein.

For example, there is proposed a technology of providing a mechanism that detects the Captive Portal state and performs user interface (UI) display on the device (see Patent Document 1). In a case where this technology is applied, a user can notice that wireless LAN connection is in the Captive Portal state by viewing the display of the UI. Then, the user inputs authentication information by himself/herself through the

UI to resolve the Captive Portal state. Thus, the device can access the Internet via the wireless LAN. This technology is assumed to be applied to a device having a UI function such as a display device and an input device. Thus, the Captive Portal state can be resolved because display on the UI and input of authentication information can be performed.

In a device that does not include a display device or an input device, however, display on the UI or input of authentication information cannot be performed. Thus, the Captive Portal state cannot be resolved by using the above technology. For example, in a case where redirection to the Captive Portal is performed, the following situation continues: although a service set identifier (SSID) and a passphrase of the wireless LAN are correct, an autonomous sensor, an autonomous robot, or various types of Internet of Things (IoT) devices cannot be connected to the Internet for some reason. In addition, an operator cannot easily know a cause of failure in connecting to the Internet.

### CITATION LIST

### Patent Document

Patent Document 1: Japanese Patent Application Laid-Open No. 2009-276925

### SUMMARY OF THE INVENTION

### Problems to be Solved by the Invention

An object of the technology disclosed herein is to provide a communication device and a communication method capable of resolving a Captive Portal state.

### Solutions to Problems

The technology disclosed herein has been made in view of the above problems, and a first aspect thereof is

a communication device including:

a first communication unit connected to a first network;

a second communication unit connected to a second network; and

a control unit that controls a network operation in each of the first and second communication units, in which

the control unit determines whether or not the second network is in a redirection state in which a destination is forcibly transferred to another specific address, and performs control to transmit information regarding redirection to the first network. Further, the control unit resolves the redirection of the second network on the basis of information received via the first network.

Further, a second aspect of the technology disclosed herein is

a communication method of a communication device connectable to a first network and a second network, the communication method including:

a step of determining whether or not the second network is in a redirection state in which a destination is forcibly transferred to another specific address; and

a step of transmitting information regarding redirection to the first network.

Furthermore, a third aspect of the technology disclosed herein is

a communication device including:

a first communication unit connected to a first network; and

a control unit that controls a network operation in the first communication unit, in which

when the control unit receives, via the first network, information regarding redirection that forcibly transfers a destination to another specific address in a second network of another device, the control unit performs control to generate information regarding resolving the redirection and transmit the information via the first network.

The communication device according to the third aspect further includes a display unit that displays the received information regarding the redirection, and an input unit that inputs the information regarding resolving the redirection.

The control unit performs control to transmit, via the first network, the setting information based on history information indicating that the communication device has previously performed an operation for resolving a redirection state.

Further, a fourth aspect of the technology disclosed herein is

a communication method of a communication device connectable to a first network and a second network, the communication method including:

a step of receiving, via the first network, information regarding redirection that forcibly transfers a destination to another specific address in a second network of another device;

a step of displaying the received information regarding the redirection;

a step of inputting information regarding resolving the redirection; and

a step of transmitting the information regarding resolving the redirection via the first network.

### Effects of the Invention

According to the technology disclosed herein, it is possible to provide a communication device and a communication method capable of resolving the Captive Portal state without using a display device or an input device.

Note that effects described herein are merely examples, and effects of the present invention are not limited thereto. Further, the present invention may also have additional effects in addition to the above-described effects.

Other objects, features, and advantages of the technology disclosed herein will be apparent from more detailed description based on embodiments described below and the accompanying drawings.

### BRIEF DESCRIPTION OF DRAWINGS

FIG. 1 illustrates a configuration example of a communication system 100 according to a first embodiment.

FIG. 2 illustrates a functional configuration example of a wireless device 200 (first embodiment).

FIG. 3 is a flowchart showing a flow of processing in which the wireless device 200 resolves a Captive Portal state in wireless LAN connection.

FIG. 4 shows a detailed procedure of network layer connection processing (first embodiment).

FIG. 5 is a flowchart showing a detailed procedure of Internet connection diagnosis processing (first embodiment).

FIG. 6 shows a detailed procedure of processing for transferring Internet connection diagnosis (first embodiment).

FIG. 7 shows a detailed procedure of Captive Portal authentication proxy processing.

FIG. 8 illustrates a configuration example of a communication system 800 according to a second embodiment.

FIG. 9 illustrates a functional configuration example of a wireless device 200 (second embodiment).

FIG. 10 shows a detailed procedure of network layer connection processing (second embodiment).

FIG. 11 is a flowchart showing a detailed procedure of Internet connection diagnosis processing (second embodiment).

FIG. 12 shows a detailed procedure of processing for transferring Internet connection diagnosis (second embodiment).

### MODE FOR CARRYING OUT THE INVENTION

Hereinafter, embodiments of the technology disclosed herein will be described in detail with reference to the drawings.

### First Embodiment

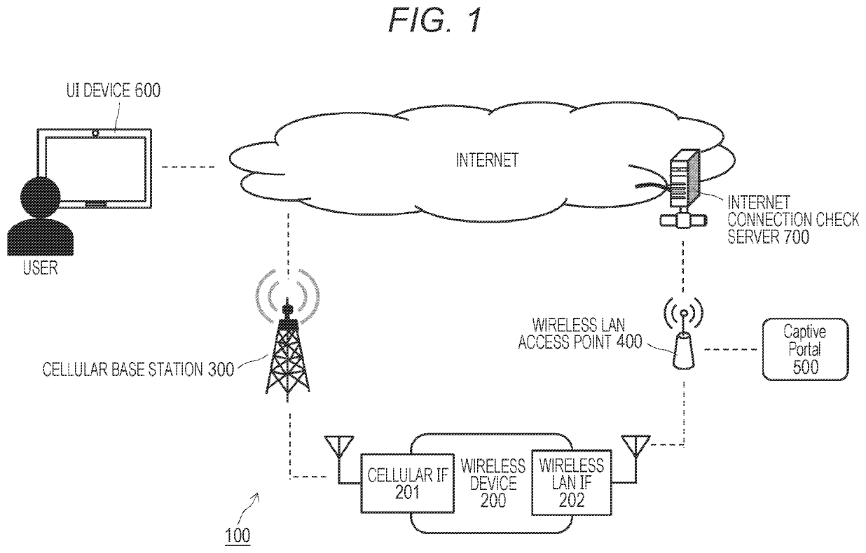

FIG. 1 schematically illustrates a configuration example of a communication system 100 according to a first embodiment.

A wireless device 200 is a device that does not include a display device or an input device. The wireless device 200 is assumed to be, for example, an autonomous sensor, an autonomous robot, or various types of IoT devices.

The wireless device 200 includes a cellular interface 201 and a wireless LAN interface 202 as a wireless interface. The cellular interface 201 is connected to a cellular base station 300 covering a current position of the wireless device 200 and is connected to the Internet via the cellular base station 300. Further, the wireless LAN interface 202 is connected to, for example, a wireless LAN access point (AP) 400 installed in the same room, and is connected to the Internet via the wireless LAN access point 400.

A wireless LAN side of the wireless device 200 is not connected in an initial state. Therefore, the wireless device 200 uses cellular communication as a default gateway. Further, the wireless device 200 operates in such a policy that, in a case where the wireless LAN side is connectable to the Internet, the wireless LAN side is preferentially used as the default gateway. This policy is based on the fact that the wireless LAN has a higher communication speed and a lower communication cost than the cellular communication, for example.

A destination to which the wireless device 200 is connected via the wireless LAN is a Captive Portal 500.

That is, the wireless LAN access point 400 requests web authentication and performs redirection to the Captive Portal 500. Therefore, the redirection by the wireless LAN access point 400 is not resolved unless the wireless device 200 performs authentication with the Captive Portal 500, and the wireless device 200 cannot be connected to the Internet via the wireless LAN.

Further, whether or not the wireless device 200 can be connected to the Internet is checked by HTTP access to an Internet connection check server 700. The Internet connection check server 700 is an online check HTTP server having a predetermined URL and configured to return a dedicated HTTP header serving as information indicating connection to the Internet (to cause an HTTP response header to include dedicated status information).

An operation of the wireless device 200 is basically performed by a user who operates a UI device 600 separate from the wireless device 200. For example, in the initial state, the wireless device 200 is operated by the user via the cellular communication. A UI of the UI device 600 may be a web browser, another native application, or an application to be installed later.

The UI device 600 is basically assumed to be a device including a display device and an input device. The UI device 600 may be, for example, an information terminal such as a personal computer, a smartphone, or a tablet. Further, connection means for connecting the UI device 600 to the Internet is not particularly limited.

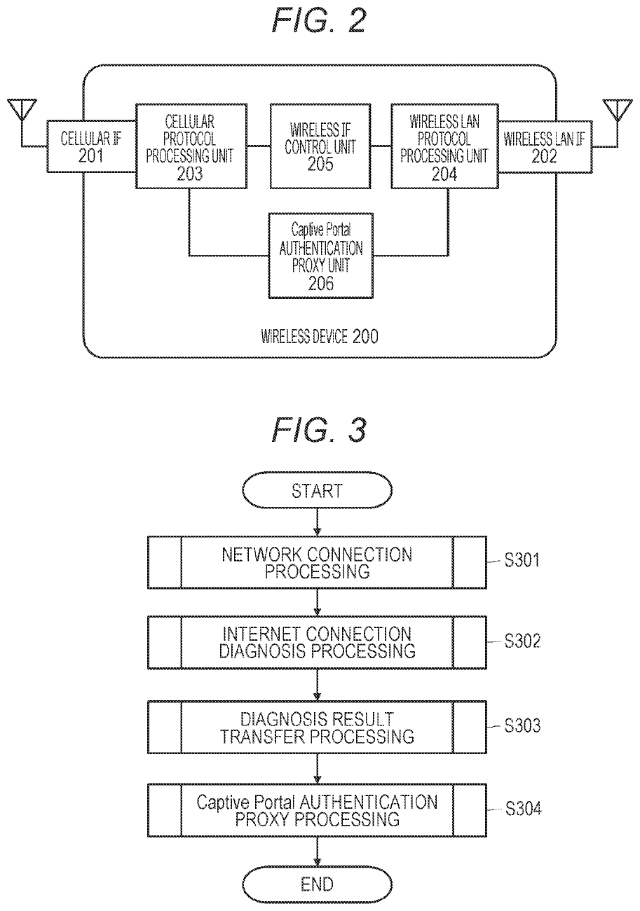

FIG. 2 illustrates a functional configuration example of the wireless device 200. The wireless device 200 of FIG. 2 includes the cellular interface 201, the wireless LAN interface 202, a cellular protocol processing unit 203, a wireless LAN protocol processing unit 204, a wireless interface control unit 205, and a Captive Portal authentication proxy unit 206. Note that the wireless device 200 may include a functional module (not illustrated) according to application, but is omitted herein for convenience of description.

The wireless interface control unit 205 diagnoses whether or not the cellular communication and the wireless LAN can secure connection to the Internet, and determines whether to switch connection used by default to access the Internet.

In a case where the wireless LAN side is in the Captive Portal state, the Captive Portal authentication proxy unit 206 transmits information regarding the Captive Portal 500 to a cellular connection side. Further, in a case where the Captive Portal authentication proxy unit 206 receives authentication information for passing through the Captive Portal 500 from the cellular side, the Captive Portal authentication proxy unit 206 uses the authentication information to perform an authentication operation for the wireless LAN side. Note that the wireless LAN is, for example, a wireless network conforming to IEEE 80.11 or Wi-Fi (registered trademark).

The cellular protocol processing unit 203 performs processing of protocols of a physical layer and a data link layer of communication to be transmitted and received by the cellular interface 201. Further, the wireless LAN protocol processing unit 204 performs processing of protocols of a physical layer and a data link layer of communication to be transmitted and received by the wireless LAN interface 201.

FIG. 3 is a flowchart showing a schematic flow of processing in which the wireless device 200 resolves the Captive Portal state in wireless LAN connection.

First, the wireless device 200 performs connection processing in a network layer (step S301). This is processing of attempting connection up to a network layer level on the wireless LAN side. Specifically, association to the wireless LAN access point 400, a security setting, and acquisition of an Internet protocol (IP) address are performed.

Next, the wireless device 200 performs Internet connection diagnosis processing (step S302). The wireless device 200 confirms Internet connection on the wireless LAN side, and, in a case where the Internet connection cannot be confirmed, the wireless device 200 classifies a factor thereof.

Next, the wireless device 200 performs processing for transferring a result of the Internet connection diagnosis processing in step S302 to the UI device 600 (step S303).

Then, the wireless device 200 obtains setting information necessary for authentication from the UI device 600, and the Captive Portal authentication proxy unit 206 performs, by proxy, authentication for resolving the Captive Portal state of the wireless device 200 (step S304).

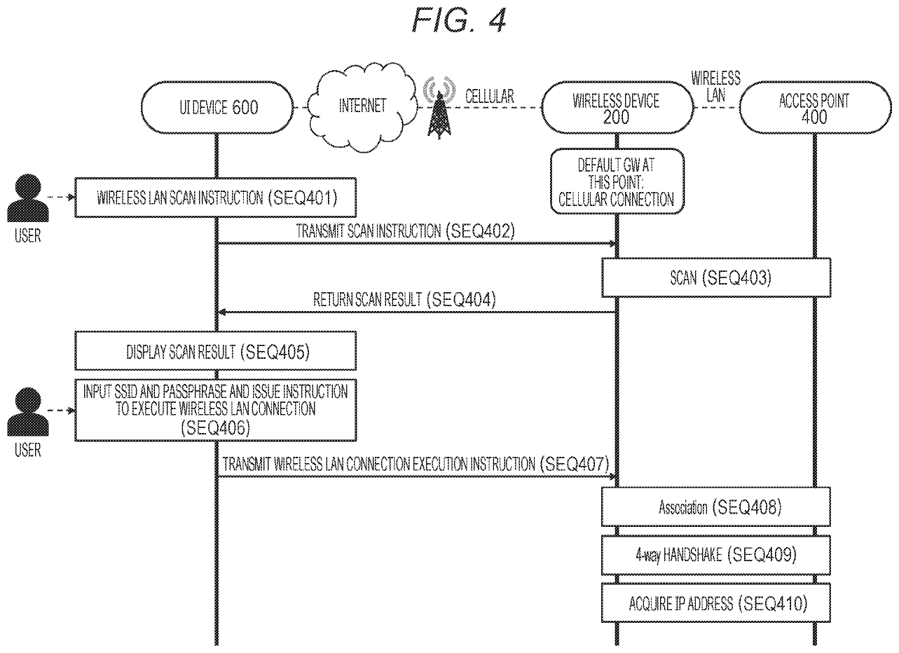

FIG. 4 shows a detailed procedure of the network layer connection processing performed in step S301 in the flowchart of FIG. 3. In the wireless device 200, the wireless interface control unit 205 mainly performs the network layer connection processing. Further, the default gateway at the start of this processing is assumed to be cellular connection. Then, during this processing, the wireless device 200 exchanges operation instructions on the UI device 600 from the user via the cellular communication.

First, the user instructs, on the UI device 600, the wireless device 200 to perform an operation of scanning the wireless LAN (SEQ401). This instruction is transmitted to the wireless device 200 via the cellular communication (SEQ402).

The wireless device 200 performs the operation of scanning the wireless LAN in response to the instruction from the UI device 600 (SEQ403). Then, the wireless device 200 returns the scan result to the UI device 600 via the cellular communication (SEQ404).

The UI device 600 displays the scan result received from the wireless device 200 on its own display device or the like (SEQ405).

Next, the user inputs an SSID (or network identification information for the wireless device 200 to perform the wireless LAN connection) and a passphrase (e.g., authentication information used when the wireless device 200 is connected to the wireless LAN access point 400, such as a Wi-Fi Protected Access Pre Shared Key (WPA-PSK)) on the UI device 600, and instructs the wireless device 200 to execute connection to the wireless LAN access point 400 (SEQ406). Then, a wireless LAN connection instruction including the SSID and the passphrase is transmitted to the wireless device 200 via the cellular communication (SEQ407).

The wireless device 200 uses the received SSID and passphrase to sequentially perform association to the wireless LAN access point 400 (SEQ408), 4-Way handshake with the wireless LAN access point 400 (SEQ409), and acquisition of an IP address (SEQ410). However, the wireless LAN connection instruction with the SSID and the passphrase may be replaced with a Wi-Fi (registered trademark) Protected Setup (WPS) execution instruction.

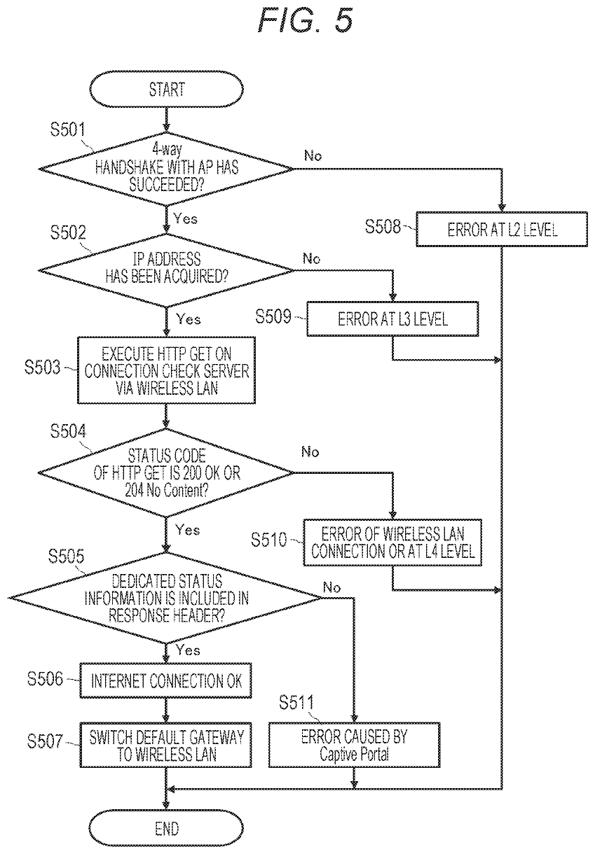

FIG. 5 is a flowchart showing a detailed procedure of the Internet connection diagnosis processing performed in step S302 in the flowchart of FIG. 3. In the wireless device 200, the wireless interface control unit 205 mainly performs the Internet connection diagnosis processing via the wireless LAN protocol processing unit 204 and the wireless LAN interface 202.

First, the wireless interface control unit 205 checks progress of the connection up to this stage.

In a case where the 4-way handshake with the wireless LAN access point 400 has not succeeded (No in step S501), the wireless interface control unit 205 sets a result of the Internet connection diagnosis to an “error at an L2 level” (step S508). This error is caused by a wrong SSID or passphrase input from the UI device 600, a failure in association connection to the wireless LAN access point 400 due to a wireless transmission error, or the like.

In a case where the 4-way handshake with the wireless LAN access point 400 has succeeded (Yes in step S501), then the wireless interface control unit 205 checks whether or not the IP address for the wireless LAN connection has been acquired (step S502).

In a case where the IP address of the wireless LAN has not been acquired (No in step S502), the wireless interface control unit 205 sets the result of the Internet connection diagnosis to an “error at an L3 level” (step S509). This error is caused by a failure in a dynamic host configuration protocol (DHCP) or the like.

In a case where the IP address of the wireless LAN has been acquired (Yes in step S502), the wireless interface control unit 205 executes Hyper Text Transfer

Protocol (HTTP) GET on a uniform resource locator (URL) of the Internet connection check server 700 (step S503).

The Internet connection check server 700 performs an operation of adding a unique online check flag to a header of a response to HTTP access to the own device. Then, the wireless interface control unit 205 checks a result of this HTTP GET (step S504).

In a case where a status code of the HTTP GET is other than “200 OK” or “204 No Content” (No in step S504), the wireless interface control unit 205 sets the result of the Internet connection diagnosis to an “error of WAN connection or at an L4 level” (step S510). This error is caused by disconnection of a wide area network (WAN) of the wireless LAN access point 400, a failure in name resolution due to an inappropriate domian name system (DNS) server setting, or the like.

In a case where the status code of the HTTP GET is “200 OK” or “204 No Content” indicating that a request has succeeded (Yes in step S504), the Internet connection check server 700 returns information corresponding to the request together with the response. Then, the wireless interface control unit 205 parses content of an HTTP header of the response.

Herein, in a case where, although “200 OK” or “204 No Content” is returned from the Internet connection check server 700, dedicated status information is not included in the header of the HTTP response, specifically, in a case where the unique online check flag described above does not exist (No in step S505), it can be determined that the response is not transmitted from the Internet connection check server 700 but is redirected from the wireless LAN access point 400 to the Captive Portal 500. Therefore, in this case, the wireless interface control unit 205 sets the result of the Internet connection diagnosis to an “error caused by Captive Portal” (step S511). In this case, the HTTP GET is redirected to the Captive Portal 500 by the wireless LAN access point 400, and an HTTP response to the HTTP GET is returned from the Captive Portal 500. The wireless device 200 receives this HTTP response.

In a case where “200 OK” or “204 No Content” is returned from the Internet connection check server 700 (Yes in step S504) and existence of the unique online check flag in the header of the HTTP response is confirmed (Yes in step S505), the wireless interface control unit 205 sets the result of the Internet connection diagnosis to “Internet connection OK” (step S506).

Then, in a case where the result of the Internet connection diagnosis is “Internet connection OK”, the wireless interface control unit 205 switches the connection used by default to the wireless LAN at this point (step S507). In other cases, the wireless interface control unit 205 maintains the cellular communication as the connection used by default.

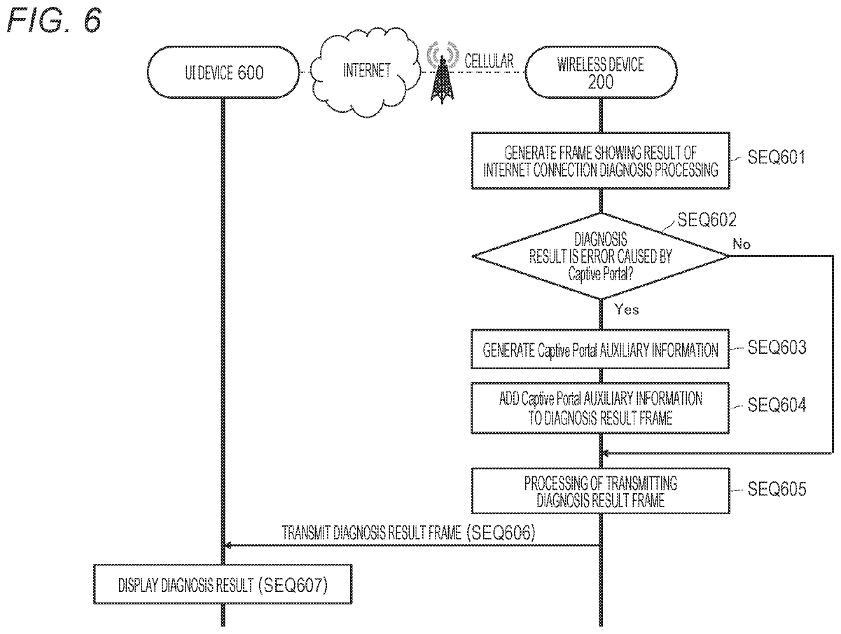

FIG. 6 shows a detailed procedure of processing for transferring the Internet connection diagnosis performed in step S303 in the flowchart of FIG. 3. In the wireless device 200, the wireless interface control unit 205 mainly performs the processing for transferring the Internet connection diagnosis.

The wireless interface control unit 205 generates a diagnosis result frame showing the result of the Internet connection diagnosis processing (SEQ601).

Only in a case where the result of the Internet connection diagnosis is the “error caused by Captive Portal” (Yes in SEQ602), the wireless interface control unit 205 further generates “Captive Portal auxiliary information” (SEQ603) and adds the “Captive Portal auxiliary information” to the diagnosis result frame (SEQ604).

The Captive Portal auxiliary information is generated on the basis of the HTTP response that is redirected to the Captive Portal 500 by the wireless LAN access point 400 and is returned from the Captive Portal 500 when the HTTP GET to the Internet connection check server is performed in the Internet connection diagnosis processing. Specific contents thereof are, for example, one of the following (a) to (c). The Captive Portal auxiliary information may be a combination of two or more of the following (a) to (c). Further, not only the following (a) to (c) but also information regarding a redirected destination URL of the Captive Portal 500 may be added as the Captive Portal auxiliary information.

(a) The whole or part of an HTTP response sentence returned from the Captive Portal 500

(b) An image showing a result of rendering the HTTP response returned from the Captive Portal 500

(c) A list of items of authentication information requested to be input by the Captive Portal 500

In a case where the Captive Portal auxiliary information is (a) described above, the wireless interface control unit 205 may encapsulate a text of the HTTP response or part thereof from the Captive Portal 500 as it is.

Further, in a case where the Captive Portal auxiliary information is (b) described above, the wireless interface control unit 205 has a function corresponding to a browser, and parses the HTTP response sentence to thereby generate an image corresponding to a browser screen. In this case, information regarding a format is also added to the diagnosis result frame so that the image can be displayed on the UI device 600.

Further, in a case where the Captive Portal auxiliary information is (c) described above, it is necessary to parse the HTTP response part and extract an item of the authentication information requested to be input.

In any of (a) to (c) described above, a purpose of adding the Captive Portal auxiliary information to the diagnosis result frame is to notify the user of the Captive Portal state, and, at the same time, to notify the user of which setting information is necessary for authentication to resolve the state.

The wireless interface control unit 205 transmits the diagnosis result frame generated as described above to the user (SEQ605). The diagnosis result frame is transmitted to the UI device 600 via the cellular communication (SEQ606).

Upon receipt of the diagnosis result frame, the UI device 600 displays, on its own display device or the like, the result of the Internet connection diagnosis with the “Captive Portal auxiliary information” that is additionally included in the diagnosis result frame in a case where the result is the “error caused by Captive Portal” (SEQ607).

In a case where the Captive Portal auxiliary information is the text of the encapsulated HTTP response, the UI device 600 browses and displays the text. For example, in a case where the UI of the UI device 600 is a web browser, the text may be parsed and displayed as it is as a browser screen. Further, in a case where the Captive Portal auxiliary information is the image showing the result of rendering the HTTP response sentence, the image may be displayed as it is on the UI device 600. Furthermore, in a case where the Captive Portal auxiliary information is the list of items of the authentication information requested to be input by the Captive Portal 500, a screen prompting the user to input the items may be displayed on the UI device 600.

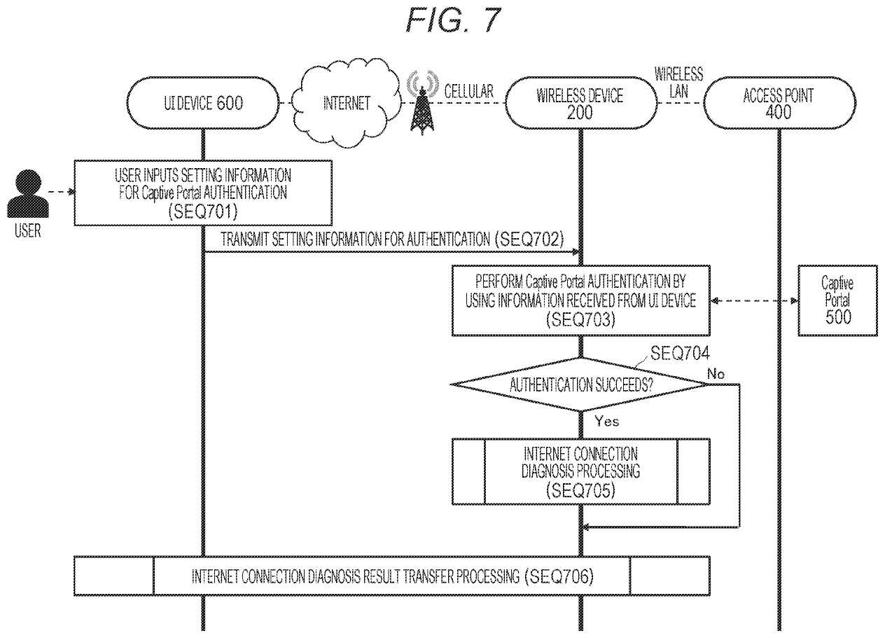

FIG. 7 shows a detailed procedure of the Captive Portal authentication proxy processing performed in step S304 in the flowchart of FIG. 3.

At this point, the user grasps that the wireless device 200 is in the Captive Portal state from the result of the Internet connection diagnosis displayed on the UI device 600 through the diagnosis result transfer processing (see FIG. 6).

The UI device 600 further shows, to the user, which setting information is necessary for authentication to resolve the Captive Portal state of the wireless device 200 by using the Captive Portal auxiliary information, and then prompts the user to input the setting information (SEQ701). Then, the UI device 600 transmits the setting information input by the user to the wireless device 200 via the cellular communication (SEQ702).

Upon receipt of the setting information from the UI device 600, the wireless device 200 passes the setting information to the Captive Portal authentication proxy unit 206 to cause the Captive Portal authentication proxy unit 206 to perform an authentication operation (SEQ703). The Captive Portal authentication proxy unit 206 performs HTTP access to the Captive Portal 500 redirected by the wireless LAN access point 400 in response to access from the wireless LAN side, and automatically attempts the authentication operation by using the setting information received from the UI device 600 on behalf of the user.

Then, the Captive Portal authentication proxy unit 206 notifies the wireless interface control unit 205 of success or failure of the authentication.

In a case where the Captive Portal authentication succeeds (Yes in SEQ704), the wireless interface control unit 205 performs the Internet connection diagnosis processing (see FIG. 5) again (SEQ705). Meanwhile, in a case where the Captive Portal authentication fails (No in SEQ704), the Internet connection diagnosis processing is not performed.

In a case where the authentication succeeds, HTTP access from the wireless device 200 to the Internet connection check server 700 is not redirected to the

Captive Portal 500. Therefore, in a case where the result of the HTTP GET is “200 OK” or “204 No Content”, existence of a unique online check flag in a header of a response to the HTTP access is expected, and the Internet connection confirmation succeeds. At this point, the connection used by default can be switched to the wireless LAN side of the wireless device 200.

Thereafter, the wireless interface control unit 205 performs the diagnosis result transfer processing to the UI device 600 (see FIG. 6) again (SEQ706) and notifies the user of a change in a situation of Internet access.

By performing the above procedures, it is possible to correctly grasp the Captive Portal state, perform the authentication operation, and resolve the Captive Portal state even in the wireless device 200 that does not include a display device or an input device.

Note that, in a case where the Captive Portal authentication proxy processing by the Captive Portal authentication proxy unit 206 succeeds, the used setting information may be stored in the wireless device 200 itself. Thereafter, in a case where the Captive Portal authentication expires, the Captive Portal authentication may be required again. In such a case, when the result of the “error caused by Captive Portal” is obtained in the Internet connection diagnosis processing, whether or not the setting information for the Captive Portal authentication has been previously stored in the wireless device 200 itself. In a case where there is available information, the diagnosis result transfer processing (step S303) in FIG. 3 may be skipped, i.e., the processing may directly proceed from the Internet connection diagnosis processing to the Captive Portal authentication proxy processing.

In the first embodiment, the wireless device 200 has two types of communication means, i.e., the cellular communication and the wireless LAN, and the Captive Portal exists on the wireless LAN connection side (see FIG. 1). However, even in a case where the Captive Portal exists on the cellular communication side and the default connection is reversed, the technology disclosed herein is similarly applicable by replacing the cellular communication with the wireless LAN and vice versa. Further, even in a case where the wireless device 200 adopts a wireless method other than Wi-Fi (registered trademark), the technology disclosed herein is similarly applicable.

In the first embodiment, the Internet connection check server, i.e., an online check server is an HTTP server, but the Internet connection confirmation may be performed by HTTPS instead of HTTP. In that case, the technology disclosed herein is similarly applicable by replacing HTTP with HTTPS.

Second Embodiment

In the first embodiment, the wireless LAN setting of the wireless device 200 is performed by the UI device 600 over the Internet by using the cellular communication. Meanwhile, in a second embodiment described below, the UI device 600 performs a setting operation more directly on the wireless device 200 via Bluetooth (registered trademark) communication. Further, in the second embodiment, the UI device 600 also includes a wireless LAN interface, and has been previously connected to the wireless LAN access point 400 to which the wireless device 200 is to be connected. Therefore, in a case where the UI device 600 has performed the subsequent Captive Portal authentication, it is possible to simplify processing for switching the connection used by default in the wireless device 200 to the wireless LAN.

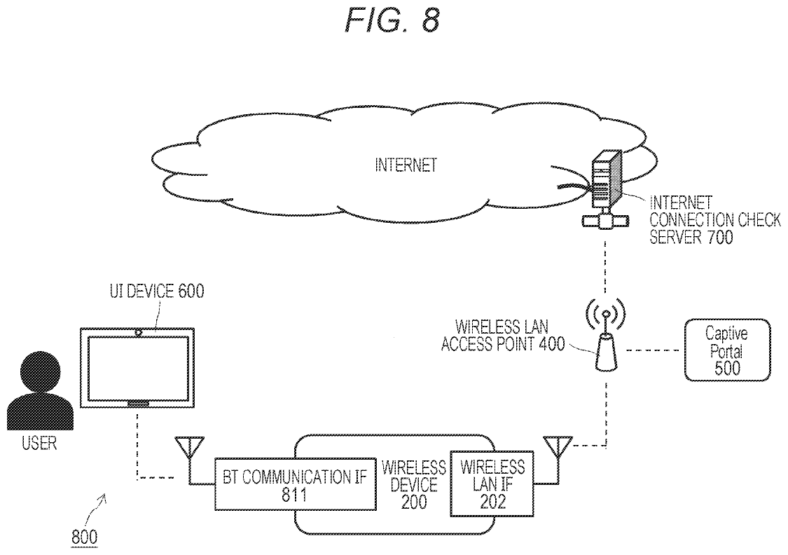

FIG. 8 schematically illustrates a configuration example of a communication system 800 according to the second embodiment.

The wireless device 200 is a device that does not include a display device or an input device. The wireless device 200 is assumed to be, for example, an autonomous sensor, an autonomous robot, or various types of IoT devices.

The wireless device 200 includes a Bluetooth (BT) communication interface 811 and a wireless LAN interface 202 as a wireless interface. The Bluetooth communication interface 811 is directly connected to the UI device 600 also including a Bluetooth communication interface (not illustrated). Further, the wireless LAN interface 202 is connected to, for example, the wireless LAN access point (AP) 400 installed in the same room, and is connected to the Internet via the wireless LAN access point 400. The wireless LAN side of the wireless device 200 is not connected in an initial state.

A destination to which the wireless device 200 is connected via the wireless LAN is the Captive Portal 500. That is, the wireless LAN access point 400 requests web authentication and performs redirection to the Captive Portal 500. Therefore, the redirection by the wireless LAN access point 400 is not resolved unless the wireless device 200 performs authentication with the Captive Portal 500, and the wireless device 200 cannot be connected to the Internet via the wireless LAN. Further, whether or not the wireless device 200 can be connected to the Internet is checked by access to the Internet connection check server 700. The Internet connection check server 700 is an online check HTTP server having a predetermined URL and configured to return a dedicated HTTP header serving as information indicating connection to the Internet (to cause an HTTP response header to include dedicated status information).

An operation of the wireless device 200 is basically performed by a user who operates the UI device 600 directly connected via the Bluetooth communication.

In the initial state, the wireless device 200 is operated by the user via the Bluetooth communication. The UI of the UI device 600 may be a web browser, another native application, or an application to be installed later.

The UI device 600 is basically assumed to be a device including a display device and an input device. The UI device 600 may be, for example, an information terminal such as a personal computer, a smartphone, or a tablet. Unlike the first embodiment, the UI device 600 includes the Bluetooth communication interface. However, connection means for connecting to the Internet is not essential.

In this embodiment, the UI device 600 also includes a wireless LAN interface. Further, in this embodiment, it is assumed that the UI device 600 has a history of previous connection to the Internet via the wireless LAN access point 400 to which the wireless device 200 is to be connected, has performed an authentication operation of the Captive Portal 500 when connecting to the Internet, and holds input setting information.

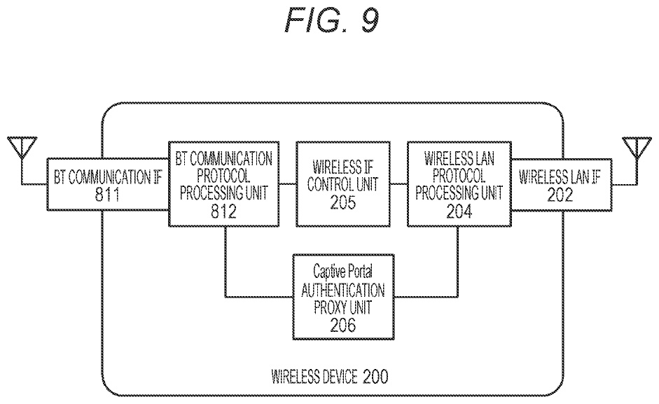

FIG. 9 illustrates a functional configuration example of the wireless device 200 in the second embodiment. The wireless device 200 of FIG. 9 includes the Bluetooth communication interface 811, the wireless LAN interface 202, a Bluetooth communication protocol processing unit 812, the wireless LAN protocol processing unit 204, the wireless interface control unit 205, and the Captive Portal authentication proxy unit 206.

The wireless device 200 in the second embodiment is configured so that the cellular interface 201 and the cellular protocol processing unit 203 of the wireless device 200 in the first embodiment are replaced with the Bluetooth communication interface 811 and the Bluetooth communication protocol processing unit 812. The Bluetooth communication protocol processing unit 812 performs processing of protocols of a physical layer and a data link layer of communication to be transmitted and received by the Bluetooth communication interface 811. The configuration is the same as that of the wireless device 200 in the first embodiment except for the Bluetooth communication interface 811 or the Bluetooth communication protocol processing unit 812. Therefore, detailed description thereof is omitted herein. Further, the wireless device 200 may include a functional module (not illustrated) according to application, but is omitted herein for convenience of description.

In the communication system 800 according to the second embodiment, as well as in the system according to the first embodiment, the wireless device 200 can resolve the Captive Portal state in the wireless LAN connection by purely executing the network layer connection processing, the Internet connection diagnosis processing, the diagnosis result transfer processing, and the Captive Portal authentication proxy processing according to the processing procedure of FIG. 3.

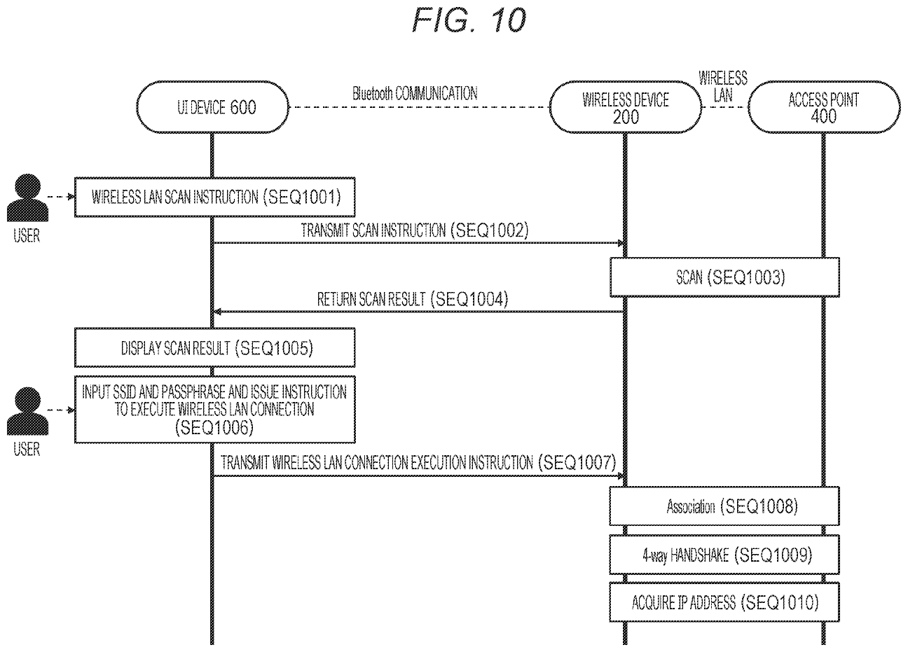

FIG. 10 shows a detailed procedure of the network layer connection processing in the second embodiment. In the wireless device 200, the wireless interface control unit 205 mainly performs the network layer connection processing. Further, during this processing, the wireless device 200 exchanges operation instructions on the UI device 600 from the user via the Bluetooth communication.

First, the user instructs, on the UI device 600, the wireless device 200 to perform an operation of scanning the wireless LAN (SEQ1001). This instruction is transmitted to the wireless device 200 via the Bluetooth communication (SEQ1002).

The wireless device 200 performs the operation of scanning the wireless LAN in response to the instruction from the UI device 600 (SEQ1003). Then, the wireless device 200 returns the scan result to the UI device 600 via the Bluetooth communication (SEQ1004).

The UI device 600 displays the scan result received from the wireless device 200 on its own display device or the like (SEQ1005).

Next, the user inputs an SSID (or network identification information for the wireless device 200 to perform the wireless LAN connection) and a passphrase (e.g., authentication information used when the wireless device 200 is connected to the wireless LAN access point 400, such as a WEP key) on the UI device 600, and instructs the wireless device 200 to execute connection to the wireless LAN access point 400 (SEQ1006). Then, a wireless LAN connection instruction including the SSID and the passphrase is transmitted to the wireless device 200 via the Bluetooth communication (SEQ1007).

The wireless device 200 uses the received SSID and passphrase to sequentially perform association to the wireless LAN access point 400 (SEQ1008), 4-Way handshake with the wireless LAN access point 400 (SEQ1009), and acquisition of an IP address (SEQ1010). However, the wireless LAN connection instruction with the SSID and the passphrase may be replaced with a WPS execution instruction.

A processing procedure of the Internet connection diagnosis processing in the second embodiment is similar to the processing procedure shown in FIG. 5 in the first embodiment, and thus the description thereof is omitted herein. The wireless device 200 can recognize, through the Internet connection diagnosis processing, which one of the following states the Internet connection state is in: the error at the L2 level, the error at the L3 level, the error of WAN connection or at the L4 level, the error caused by Captive Portal, and the Internet connection OK.

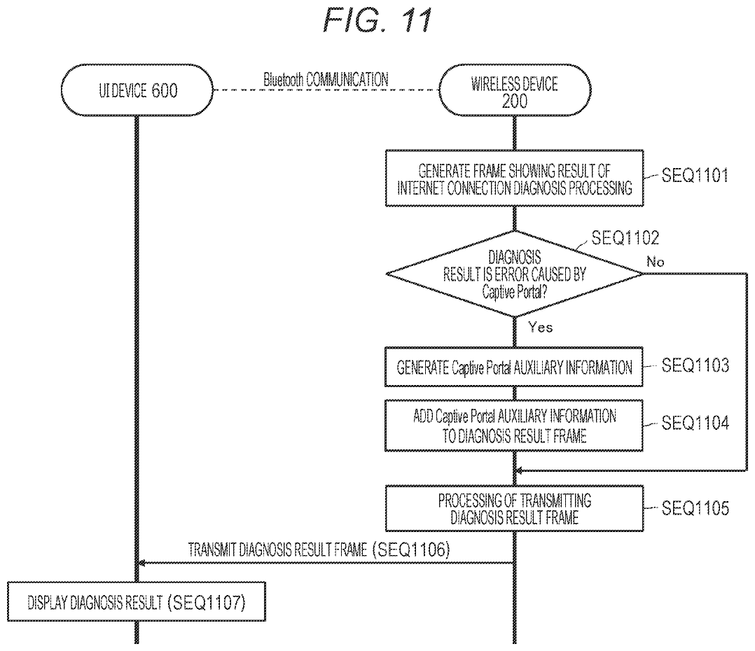

FIG. 11 shows a detailed procedure of processing for transferring a result of the Internet connection diagnosis in the second embodiment. In the wireless device 200, the wireless interface control unit 205 mainly performs the processing for transferring the

Internet connection diagnosis. Further, during this processing, the wireless device 200 communicates with the UI device 600 via the Bluetooth communication.

The wireless interface control unit 205 generates a diagnosis result frame showing the result of the Internet connection diagnosis processing (SEQ1101).

Only in a case where the result of the Internet connection diagnosis is the “error caused by Captive Portal” (Yes in SEQ1102), the wireless interface control unit 205 further generates “Captive Portal auxiliary information” (SEQ1103) and adds the “Captive Portal auxiliary information” to the diagnosis result frame (SEQ1104).

The Captive Portal auxiliary information is generated on the basis of the HTTP response that is redirected to the Captive Portal 500 by the wireless LAN access point 400 and is returned from the Captive Portal 500 when the HTTP GET to the Internet connection check server is performed in the Internet connection diagnosis processing. Specific contents thereof are, for example, one of the following (a) to (c). The Captive Portal auxiliary information may be a combination of two or more of the following (a) to (c). Further, not only the following (a) to (c) but also information regarding a redirected destination URL of the Captive Portal 500 may be added as the Captive Portal auxiliary information.

(a) The whole or part of an HTTP response sentence returned from the Captive Portal 500

(b) An image showing a result of rendering the HTTP response returned from the Captive Portal 500

(c) A list of items of authentication information requested to be input by the Captive Portal 500

In a case where the Captive Portal auxiliary information is (a) described above, the wireless interface control unit 205 may encapsulate a text of the HTTP response or part thereof from the Captive Portal 500 as it is.

Further, in a case where the Captive Portal auxiliary information is (b) described above, the wireless interface control unit 205 has a function corresponding to a browser, and parses the HTTP response sentence to thereby generate an image corresponding to a browser screen. In this case, information regarding a format is also added to the diagnosis result frame so that the image can be displayed on the UI device 600.

Further, in a case where the Captive Portal auxiliary information is (c) described above, it is necessary to parse the HTTP response part and extract an item of the authentication information requested to be input.

In any of (a) to (c) described above, a purpose of adding the Captive Portal auxiliary information to the diagnosis result frame is to notify the user of the Captive Portal state, and, at the same time, to notify the user of which setting information is necessary for authentication to resolve the state.

The wireless interface control unit 205 transmits the diagnosis result frame generated as described above to the user (SEQ1105). The diagnosis result frame is transmitted to the UI device 600 via the Bluetooth communication (SEQ1106).

Upon receipt of the diagnosis result frame, the UI device 600 displays, on its own display device or the like, the result of the Internet connection diagnosis with the “Captive Portal auxiliary information” that is additionally included in the diagnosis result frame in a case where the result is the “error caused by Captive Portal” (SEQ1107).

In a case where the Captive Portal auxiliary information is the text of the encapsulated HTTP response, the UI device 600 browses and displays the text. For example, in a case where the UI of the UI device 600 is a web browser, the text may be parsed and displayed as it is as a browser screen. Further, in a case where the Captive Portal auxiliary information is the image showing the result of rendering the HTTP response sentence, the image may be displayed as it is on the UI device 600. Furthermore, in a case where the Captive Portal auxiliary information is the list of items of the authentication information requested to be input by the Captive Portal 500, a screen prompting the user to input the items may be displayed on the UI device 600.

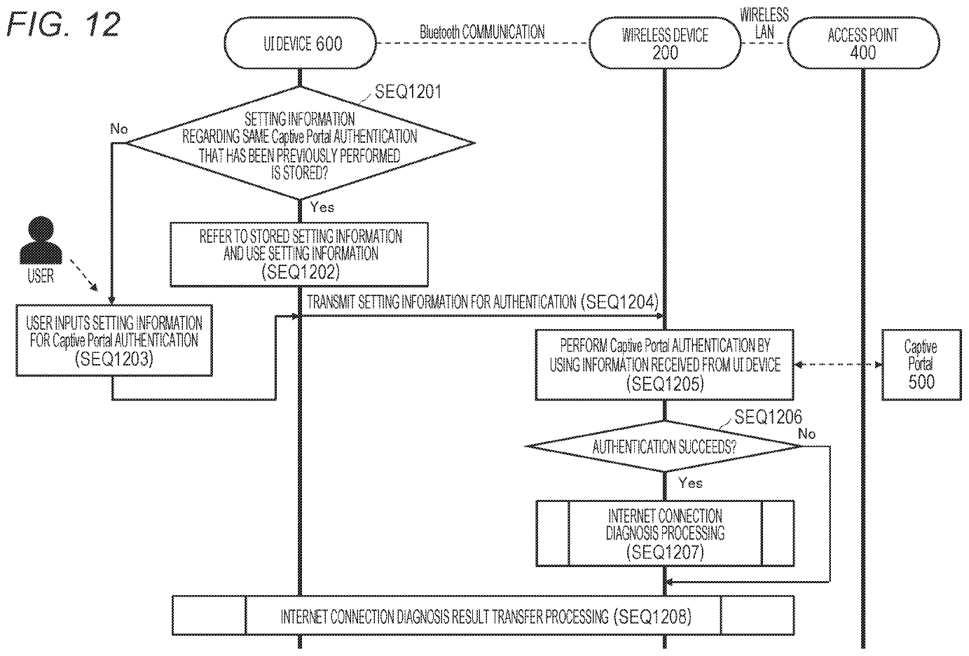

FIG. 12 shows a detailed procedure of the Captive Portal authentication proxy processing in the second embodiment.

At this point, the user grasps that the wireless device 200 is in the Captive Portal state from the result displayed on the UI device 600 through the diagnosis result transfer processing (see FIG. 11).

The UI device 600 checks whether or not setting information regarding authentication that the UI device itself has previously performed for the same Captive Portal 500 is stored (SEQ1201). Specifically, the UI device 600 that has received the result of the Internet connection diagnosis indicating the “error caused by Captive Portal” and the “Captive Portal auxiliary information” first extracts information regarding a redirected URL of the Captive Portal 500 from the contents of the Captive Portal auxiliary information, and checks whether or not there is a history that the UI device has previously performed an authentication operation for the Captive Portal 500.

In a case where there is a history of the authentication operation for the Captive Portal 500 and the setting information input at that time is stored (Yes in SEQ1201), the UI device 600 uses the information (SEQ1202) and transmits the setting information to the wireless device 200 via the Bluetooth communication (SEQ1204).

Further, in a case where the previous setting information is not stored (No in SEQ1201), the UI device 600 shows, to the user, which setting information is necessary for authentication to resolve the Captive Portal state of the wireless device 200, and then prompts the user to input the setting information (SEQ1203). Then, the UI device 600 transmits the input setting information to the wireless device 200 via the Bluetooth communication (SEQ1204).

Upon receipt of the setting information from the UI device 600, the wireless device 200 passes the setting information to the Captive Portal authentication proxy unit 206 to cause the Captive Portal authentication proxy unit 206 to perform an authentication operation (SEQ1205). The Captive Portal authentication proxy unit 206 performs HTTP access to the Captive Portal 500 redirected by the wireless LAN access point 400 in response to access from the wireless LAN side, and automatically attempts the authentication operation by using the setting information received from the UI device 600 on behalf of the user. Then, the Captive Portal authentication proxy unit 206 notifies the wireless interface control unit 205 of success or failure of the authentication.

In a case where the Captive Portal authentication succeeds (Yes in SEQ1206), the wireless interface control unit 205 performs the Internet connection diagnosis processing again (SEQ1207). Meanwhile, in a case where the Captive Portal authentication fails (No in SEQ1206), the Internet connection diagnosis processing is not performed.

In a case where the authentication succeeds, HTTP access from the wireless device 200 to the Internet connection check server 700 is not redirected to the Captive Portal 500. Therefore, in a case where the result of the HTTP GET is “200 OK” or “204 No Content”, existence of a unique online check flag in a header of a response to the HTTP access is expected, and the Internet connection confirmation succeeds. At this point, the wireless device 200 can be connected to the Internet from the wireless LAN side.

Thereafter, the wireless interface control unit 205 performs the diagnosis result transfer processing to the UI device 600 again (SEQ1208) and notifies the user of a change in a situation of Internet access.

By performing the above procedures, it is possible to correctly grasp the Captive Portal state, perform the authentication operation, and resolve the Captive Portal state even in the wireless device 200 that does not include a display device or an input device.

Note that, in a case where the Captive Portal authentication proxy processing by the Captive Portal authentication proxy unit 206 succeeds, the used setting information may be stored in the wireless device 200 itself. Thereafter, in a case where the Captive Portal authentication expires, the Captive Portal authentication may be required again. In such a case, when the result of the “error caused by Captive Portal” is obtained in the Internet connection diagnosis processing, whether or not the setting information for the Captive Portal authentication has been previously stored in the wireless device 200 itself. In a case where there is available information, the diagnosis result transfer processing (step S303) in FIG. 3 may be skipped, i.e., the processing may directly proceed from the Internet connection diagnosis processing to the Captive Portal authentication proxy processing.

Note that, in the Captive Portal authentication proxy processing according to the second embodiment, even in a case where the setting information is stored in the

UI device 600, an interaction for prompting the user to confirm the use of the information may be performed through the UI on the UI device 600 before the setting information is transmitted to the wireless device 200.

In the second embodiment, the wireless device 200 includes two types of communication means, i.e., Bluetooth and wireless LAN, and communication with the UI device is performed by using Bluetooth that is a local wireless connection. Meanwhile, the communication with the UI device may be performed by using Wi-Fi Direct instead of Bluetooth as the local wireless connection. Even in this case, the technology disclosed herein is similarly applicable by replacing the Bluetooth communication with Wi-Fi Direct communication. In this case, the wireless device 200 selectively uses two kinds of wireless LAN connection, i.e., wireless LAN connection for the Internet connection and wireless LAN connection for the Wi-Fi Direct communication with the UI device.

Also in the second embodiment, the Internet connection confirmation may be performed by HTTPS instead of HTTP. In that case, the technology disclosed herein is similarly applicable by replacing HTTP with HTTPS.

### INDUSTRIAL APPLICABILITY

As described above, the technology disclosed herein has been described in detail with reference to specific embodiments. However, it is obvious that those skilled in the art can make modifications and substitutions of the embodiments, without departing from the scope of the technology disclosed herein.

The technology disclosed herein is applicable to various types of wireless devices that do not include a display device or an input device, such as an autonomous sensor, an autonomous robot, or various types of IoT devices. As a matter of course, the technology disclosed herein is also similarly applicable to information devices including a display device and an input device, such as a smartphone, a tablet, and a personal computer.

In this specification, there has been described an embodiment in which cellular communication and Bluetooth communication are used as means for connecting the wireless device and the UI device to which the user inputs setting information for Captive Portal authentication. However, the technology is not limited to the above communication means. The wireless device and the UI device may be connected by using near field communication (NFC), other wireless communication means, wireless communication means based on its own standard, a universal serial bus (USB), or other wired communication means.

In short, although the technology disclosed herein has been described by using examples, the content of description herein should not be interpreted in a limited manner. The claims should be taken into consideration in order to determine the gist of the technology disclosed herein.

Note that the technology disclosed herein can also be configured as follows.

(1) A communication device including:

a first communication unit connected to a first network;

a second communication unit connected to a second network; and

a control unit that controls a network operation in each of the first and second communication units, in which

the control unit determines whether or not the second network is in a redirection state in which a destination is forcibly transferred to another specific address, and performs control to transmit information regarding redirection to the first network.

(2) The communication device according to (1), in which

the control unit resolves the redirection of the second network on the basis of information received via the first network.

(3) The communication device according to (1) or (2), in which

the control unit determines whether or not the second communication unit is in a Captive Portal state in which the second communication unit is redirected to a Captive Portal by an access point connected via the second network, and performs control to transmit information regarding the Captive Portal to the first network.

(4) The communication device according to (3), in which

the control unit determines whether or not the second communication unit is in the Captive Portal state on the basis of a result of accessing an online check server on the Internet via the second network.

(5) The communication device according to (4), in which:

the online check server returns a dedicated HTTP header; and

the control unit determines whether or not the second communication unit is in the Captive Portal state on the basis of whether or not the dedicated HTTP header is included in a result of HTTP GET for a URL of the online check server.

(6) The communication device according to (5), in which

the control unit generates the information regarding the Captive Portal on the basis of an HTTP response returned from the Captive Portal when the HTTP GET is performed on the online check server.

(7) The communication device according to any one of (3) to (6), in which

the information regarding the Captive Portal includes at least one of an HTTP response sentence returned from the Captive Portal or part of the HTTP response sentence, an image obtained by rendering an HTTP response returned from the Captive Portal, or an item of authentication information requested to be input by the Captive Portal.

(8) The communication device according to any one of (3) to (7), in which

the control unit performs an authentication operation for the Captive Portal on the basis of the information received via the first network.

(9) The communication device according to any one of (1) to (8), in which

the first communication unit is connected to cellular or Bluetooth communication.

(10) The communication device according to any one of (1) to (9), in which

the second communication unit is connected to a wireless LAN.

(11) A communication method of a communication device connectable to a first network and a second network, the communication method including:

a step of determining whether or not the second network is in a redirection state in which a destination is forcibly transferred to another specific address; and

a step of transmitting information regarding redirection to the first network.

(12) A communication device including:

a first communication unit connected to a first network; and

a control unit that controls a network operation in the first communication unit, in which

when the control unit receives, via the first network, information regarding redirection that forcibly transfers a destination to another specific address in a second network of another device, the control unit performs control to generate information regarding resolving the redirection and transmit the information via the first network.

(13) The communication device according to (12), further including:

a display unit that displays the received information regarding the redirection; and

an input unit that inputs the information regarding resolving the redirection.

(14) The communication device according to (12) or (13), in which:

the information regarding the redirection is information regarding a Captive Portal state in which the another device is redirected to Captive Portal by an access point connected via the second network; and

the control unit performs control to generate setting information necessary for authentication to resolve the Captive Portal state and transmit the setting information via the first network.

(15) The communication device according to (14), in which

the control unit performs control to generate the setting information on the basis of history information indicating that the communication device has previously performed an authentication operation for the Captive Portal and transmit the setting information via the first network.

(16) A communication method of a communication device connectable to a first network and a second network, the communication method including:

a step of receiving, via the first network, information regarding redirection that forcibly transfers

a destination to another specific address in a second network of another device;

a step of displaying the received information regarding the redirection;

a step of inputting information regarding resolving the redirection; and

a step of transmitting the information regarding resolving the redirection via the first network.

### REFERENCE SIGNS LIST

100 Communication system (first embodiment)
200 Wireless device
201 Cellular interface
202 Wireless LAN interface
203 Cellular protocol processing unit
204 Wireless LAN protocol unit
205 Wireless interface control unit
206 Captive Portal authentication proxy unit
300 Cellular base station
400 Wireless LAN access point
500 Captive Portal
600 UI device
700 Internet connection check server
800 Communication system (second embodiment)
811 Bluetooth communication interface
812 Bluetooth communication protocol processing unit

1. A communication device comprising:
a first communication unit connected to a first network;
a second communication unit connected to a second network; and
a control unit that controls a network operation in each of the first and second communication units, wherein
the control unit determines whether or not the second network is in a redirection state in which a destination is forcibly transferred to another specific address, and performs control to transmit information regarding redirection to the first network.

2. The communication device according to claim 1, wherein
the control unit resolves the redirection of the second network on a basis of information received via the first network.

3. The communication device according to claim 1, wherein
the control unit determines whether or not the second communication unit is in a Captive Portal state in which the second communication unit is redirected to a Captive Portal by an access point connected via the second network, and performs control to transmit information regarding the Captive Portal to the first network.

4. The communication device according to claim 3, wherein
the control unit determines whether or not the second communication unit is in the Captive Portal state on a basis of a result of accessing an online check server on the Internet via the second network.

5. The communication device according to claim 4, wherein:
the online check server returns a dedicated HTTP header; and
the control unit determines whether or not the second communication unit is in the Captive Portal state on a basis of whether or not the dedicated HTTP header is included in a result of HTTP GET for a URL of the online check server.

6. The communication device according to claim 5, wherein
the control unit generates the information regarding the Captive Portal on a basis of an HTTP response returned from the Captive Portal when the HTTP GET is performed on the online check server.

7. The communication device according to claim 3, wherein
the information regarding the Captive Portal includes at least one of an HTTP response sentence returned from the Captive Portal or part of the HTTP response sentence, an image obtained by rendering an HTTP response returned from the Captive Portal, or an item of authentication information requested to be input by the Captive Portal.

8. The communication device according to claim 3, wherein
the control unit performs an authentication operation for the Captive Portal on a basis of the information received via the first network.

9. The communication device according to claim 1, wherein
the first communication unit is connected to cellular or Bluetooth communication.

10. The communication device according to claim 1, wherein
the second communication unit is connected to a wireless LAN.

11. A communication method of a communication device connectable to a first network and a second network, the communication method comprising:
a step of determining whether or not the second network is in a redirection state in which a destination is forcibly transferred to another specific address; and
a step of transmitting information regarding redirection to the first network.

12. A communication device comprising:
a first communication unit connected to a first network; and
a control unit that controls a network operation in the first communication unit, wherein
when the control unit receives, via the first network, information regarding redirection that forcibly transfers a destination to another specific address in a second network of another device, the control unit performs control to generate information regarding resolving the redirection and transmit the information via the first network.

13. The communication device according to claim 12, further comprising:
a display unit that displays the received information regarding the redirection; and
an input unit that inputs the information regarding resolving the redirection.

14. The communication device according to claim 12, wherein:
the information regarding the redirection is information regarding a Captive Portal state in which the another device is redirected to a Captive Portal by an access point connected via the second network; and
the control unit performs control to generate setting information necessary for authentication to resolve the Captive Portal state and transmit the setting information via the first network.

15. The communication device according to claim 14, wherein
the control unit performs control to generate the setting information on a basis of history information indicating that the communication device has previously performed an authentication operation for the Captive Portal and transmit the setting information via the first network.

16. A communication method of a communication device connectable to a first network and a second network, the communication method comprising:
a step of receiving, via the first network, information regarding redirection that forcibly transfers a destination to another specific address in a second network of another device;
a step of displaying the received information regarding the redirection;
a step of inputting information regarding resolving the redirection; and
a step of transmitting the information regarding resolving the redirection via the first network.
